(19) United States
(12) Patent Application Publication
(10) Pub. No.: US 2005/0069833 A1
(43) Pub. Date: Mar. 31, 2005

(54) Orthodontic bracket and arch wire

(76) Inventor: Kunio Chikami, Kochi-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/954,420

(22) Filed: Oct. 1, 2004

Related U.S. Application Data
(63) Continuation-in-part of application No. PCT/JP03/15578, filed on Dec. 5, 2003.

(30) Foreign Application Priority Data
Jan. 7, 2003 (WO) PCT/JP03/00031

(51) Int. Cl. A61C 3/00

(52) U.S. Cl. 433/9; 433/13

(57) ABSTRACT

An orthodontic bracket of the present invention is an orthodontic bracket to be attached through adhesive to an individual tooth in an alignment of teeth including a tooth to be corrected comprising two claws faced to each other, the two claws forming therebetween an engaging slot for engaging an arch wire and the engaging slot having a T-shaped cross section, and a fixed spacer provided on the bottom of the engaging slot.

### CROSS-REFERENCE TO RELATED APPLICATION

This is a continuation-in-part of PCT international application No. PCT/JP2003/015578 filed on Dec. 5, 2003 incorporated herein by reference.

### TECHNICAL FIELD

The present invention relates to orthodontic brackets and arch wires, and more particularly to orthodontic brackets including fixed spacers formed at least on the bottom of an engaging slot and arch wires including a waveform curved surface formed at the portion which, when inserted into such brackets, contacts the inside surface of the bracket.

### BACKGROUND ART

The present inventors have previously proposed an orthodontic bracket 20 which is secured to the surface of a tooth T by adhesive 40 as illustrated in FIG. 17 (See, for example, U.S. Pat. No. 5,474,447 (FIGS. 1 to 6 in the third and forth boxes)).

The orthodontic bracket 20 illustrated in FIG. 17 has a substantially C-shape cross section. An arch wire 30 having an outer shape complementary to the shape of the inside space of the orthodontic bracket 20 is inserted through the orthodontic bracket 20.

The conventional orthodontic apparatus illustrated in FIG. 17 is made of dental alloy materials, ceramics, synthetic resins, etc. As such a synthetic resin, dental resins such as polymethyl methacrylate, polyoxymethylene, polycarbonate, etc., having high strength, less moisture absorption and anti-plastic-deformation in moist atmospheres at from 30 to 50° C. are employed. Also, as such a synthetic resin, other synthetic resins such as polyolefin, polyvinyl chloride, polyester, etc., or composite materials of these polymeric materials and various fibrous or powdery fillers of ceramics, metal, glass, etc., blended therein are employed.

Further, U.S. Pat. No. 5,474,447 discloses that the arch wire 30 is made of the same material as the aforementioned orthodontic bracket 20 and the arch wire 30 is shaped to have a T-shape cross section as illustrated in FIG. 17, a rectangular cross section, a square cross section, a round cross section, or a Π-shape cross section.

The orthodontic bracket 20 illustrated in FIG. 17 has a problem that the arch wire 30 and the bottom of the orthodontic bracket 20 are in surface contact with each other, resulting in large friction and poor slippage. Furthermore, there is a problem that when an arch wire having an outer shape not complementary to the inside space of the orthodontic bracket 20 illustrated in FIG. 17 is applied to the orthodontic bracket, there will be a play space of the arch wire within the inside space of the orthodontic bracket. Therefore, in producing a torque by twisting the arch wire, the torque can not be sufficiently produced even if the arch wire is ligatured by a ligaturing wire or module.

Further, the conventional orthodontic bracket has a problem that the orthodontic bracket is easily disengaged from the tooth surface since the bonding surface contacting the tooth surface has a flat shape.

Further, the prior art arch wire illustrated in FIG. 17 has a wide bottom. Therefore, when the arch wire is used in early stages of treatment where the teeth irregularity has not been corrected, the arch wire may experience excessive bending stresses and get deformed since the arch wire can not sufficiently follow large bending, which may result in degraded elasticity of the arch wire or breakage of the arch wire.

It is a first object of the present invention to provide orthodontic brackets which overcome the aforementioned problems in the prior art, have a reduced contact area between the arch wire and the orthodontic bracket bottom, require no ligature with a ligaturing wire or module, and are less prone to get disengaged from a tooth surface.

It is a second object of the present invention to provide arch wires which, even when used in early stages of treatment, sufficiently follow large bending, do not experience excessive bending stresses, and are less susceptible to deformation, maintain the elasticity, and prevent breakage.

### DISCLOSURE OF INVENTION

An orthodontic bracket according to a first aspect of the present invention is an orthodontic bracket to be attached through adhesive to an individual tooth in an alignment of teeth including a tooth to be corrected comprising: two claws faced to each other, the two claws forming therebetween an engaging slot for engaging an arch wire and the engaging slot having a T-shaped cross section; and a fixed spacer provided on the bottom of the engaging slot.

Preferably, the fixed spacer comprises two protruded strips which are in parallel and formed continuously or discontinuously.

Preferably, the two protruded strips are spaced apart by about 0.25 to 0.75 mm.

Preferably, a movable spacer is to be inserted into the engaging slot and the movable spacer comprises two legs and a coupling portion coupling the two legs. When the movable spacer is inserted into the engaging slot, the movable spacer is placed within the engaging slot such that the two legs are straddle the fixed spacer and at least the outer surfaces of the legs and the inside surfaces of the claws are contact with each other, and the gap between the two claws is blocked by the coupling portion.

Also, preferably, an undercut is formed at the portion which faces to a tooth surface, and the undercut is formed from at least two legs each having a substantially dovetail shape cross section. Of course, an uneven formation, such as small embossment, is included in the concept of above-mentioned undercut.

An second aspect of the present invention is an arch wire to be inserted into the above-described orthodontic bracket described comprising waveform curved surface formed at the portions which, when the arch wire is inserted into the bracket, contact the inside surfaces of the bracket.

An third aspect of the present invention is an orthodontic bracket to be attached through adhesive to an individual tooth in an alignment of teeth including a tooth to be corrected, comprising:
base, two claws faced to each other and protruded arcuately from the base, and an undercut formed on the side of the base which is opposite the surface on which the two claws are formed,
wherein a metal arch wire having a round cross section can be mounted between the two claws faced to each other. Of course, an uneven formation, such as small embossment, is included in the concept of above-mentioned undercut.

An forth aspect of the present invention is an orthodontic bracket to be attached through adhesive to an individual tooth in an alignment of teeth including a tooth to be corrected, comprising:
base, two claws faced to each other, the claws being protruded from the base and bent, and an undercut formed on the side of the base which is opposite the surface on which the two claws are formed,
wherein a synthetic resin arch wire having a substantially cuneiform shape cross section can be mounted between the two claws faced to each other. Of course, an uneven formation, such as small embossment, is included in the concept of above-mentioned undercut.

### BRIEF DESCRIPTION OF DRAWINGS

FIG. 1 is a perspective view illustrating an orthodontic bracket according to one embodiment of the present invention.

FIG. 2 is a perspective view illustrating a stopper according to another embodiment of the present invention.

FIG. 3 is an explanation drawing illustrating the orthodontic bracket of FIG. 1 attached to a tooth surface, onto which an arch wire having a T-shape cross section has been mounted.

FIG. 4 is an explanation drawing illustrating the orthodontic bracket of FIG. 1 onto which an arch wire having a round cross section and a stopper have been mounted.

FIG. 5 is an explanation drawing illustrating the orthodontic bracket of FIG. 1 onto which an arch wire having a rectangular cross section and a stopper have been mounted.

FIG. 6 is a plan view illustrating a modification of the stopper of FIG. 2.

FIG. 7 is a plan view illustrating another modification of the stopper of FIG. 2.

FIG. 8 is a plan view illustrating a further modification of the stopper of FIG. 2.

FIG. 9 is a perspective view illustrating another example of the stopper, which has been mounted on the orthodontic bracket of FIG. 1 according to one embodiment of the present invention and an arch wire.

FIG. 10 is a front view of the stopper of FIG. 9.

FIG. 11 is a perspective view illustrating an example of an orthodontic bracket according to an alternative embodiment of the present invention.

FIG. 12 is a perspective view illustrating another example of the orthodontic bracket according to the alternative embodiment of the present invention.

FIG. 13 is a perspective view illustrating a further example of the orthodontic bracket according to the alternative embodiment of the present invention.

FIG. 14 is a perspective view illustrating a further example of the orthodontic bracket according to the alternative embodiment of the present invention.

FIG. 15 is a perspective view illustrating an example of an orthodontic bracket according to a further alternative embodiment of the present invention.

FIG. 16 is a perspective view illustrating another example of the orthodontic bracket according to the further alternative embodiment of the present invention.

FIG. 17 is an explanation view illustrating a conventional orthodontic bracket, onto which an arch wire has been mounted.

FIG. 18 is an explanation view illustrating a peel strength test method.

FIG. 19 is an explanation view illustrating a destructive strength test method.

FIG. 20(a) is an explanation view illustrating a followability test method.

FIG. 20(b) is an explanation view illustrating a slippage test method.

FIG. 21 is a perspective view illustrating a further example of the orthodontic bracket according to the further alternative embodiment of the present invention.

FIG. 22 is an explanation view illustrating the orthodontic bracket of FIG. 21 and an arch wire just before the arch wire is mounted onto the orthodontic bracket.

FIG. 23 is an explanation view illustrating the orthodontic bracket of FIG. 21 and the arch wire wherein the arch wire has been mounted onto the orthodontic bracket.

FIG. 24 is a cross sectional explanation view of the orthodontic bracket of FIG. 21.

FIG. 25 is a cross sectional explanation view illustrating a modification of the orthodontic bracket of FIG. 21.

FIG. 26 is a perspective view illustrating an orthodontic bracket according to a further alternative embodiment of the present invention and an arch wire just before the arch wire is mounted onto the orthodontic bracket.

FIG. 27 is an explanation view illustrating the orthodontic bracket of FIG. 26 onto which the arch wire has been mounted.

FIG. 28 is an explanation view illustrating a modification of the arch wire which is applied to the orthodontic bracket of FIG. 26.

FIG. 29 is an explanation view illustrating another modification of the arch wire which is applied to the orthodontic bracket of FIG. 26.

FIG. 30 is an explanation view illustrating a further modification of the arch wire which is applied to the orthodontic bracket of FIG. 26.

FIG. 31 is an explanation view illustrating a further modification of the arch wire which is applied to the orthodontic bracket of FIG. 26.

FIG. 32 is an explanation view illustrating a further modification of the arch wire which is applied to the orthodontic bracket of FIG. 26.

FIG. 33 is an explanation view illustrating a further modification of the arch wire which is applied to the orthodontic bracket of FIG. 26.

FIG. 34 is a cross sectional explanation view illustrating a modification of the orthodontic bracket of FIG. 21.

FIG. 35 is a perspective view illustrating an arch wire which is applied to the orthodontic bracket of FIG. 34.

FIG. 36 is a cross sectional explanation view illustrating a conventional orthodontic bracket and an arch wire which is applied to this orthodontic bracket.

FIG. 37 is a perspective view illustrating pliers for mounting the arch wire of FIG. 35 onto the bracket of FIG. 34.

FIG. 38 is an explanation view illustrating a method for mounting an arch wire onto a bracket utilizing the pliers of FIG. 37.

FIG. 39 is an explanation view illustrating the method for mounting an arch wire onto a bracket utilizing the pliers of FIG. 37.

FIG. 40 is an explanation view illustrating the procedure for obtaining the load.

### BEST MODE FOR CARRYING OUT THE INVENTION

Hereinafter, the orthodontic brackets and the arch wires of the present invention will be explained in detail with reference to the accompanying drawings.

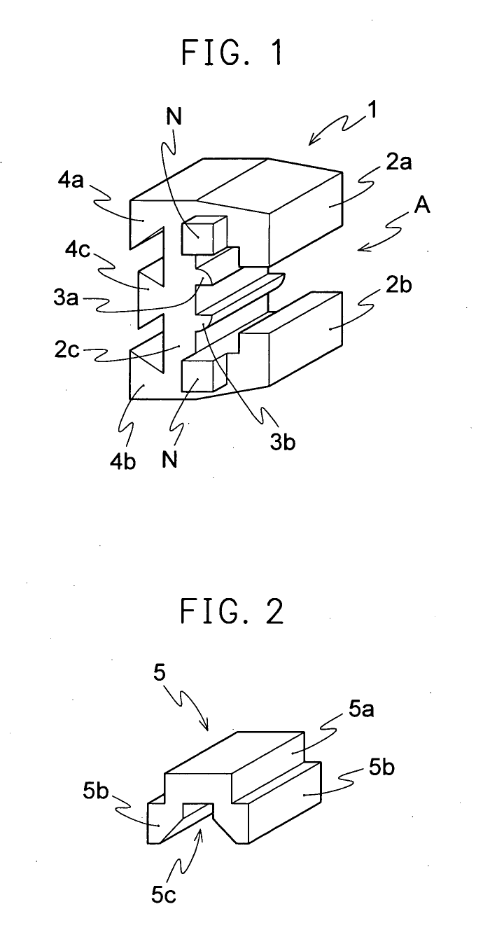

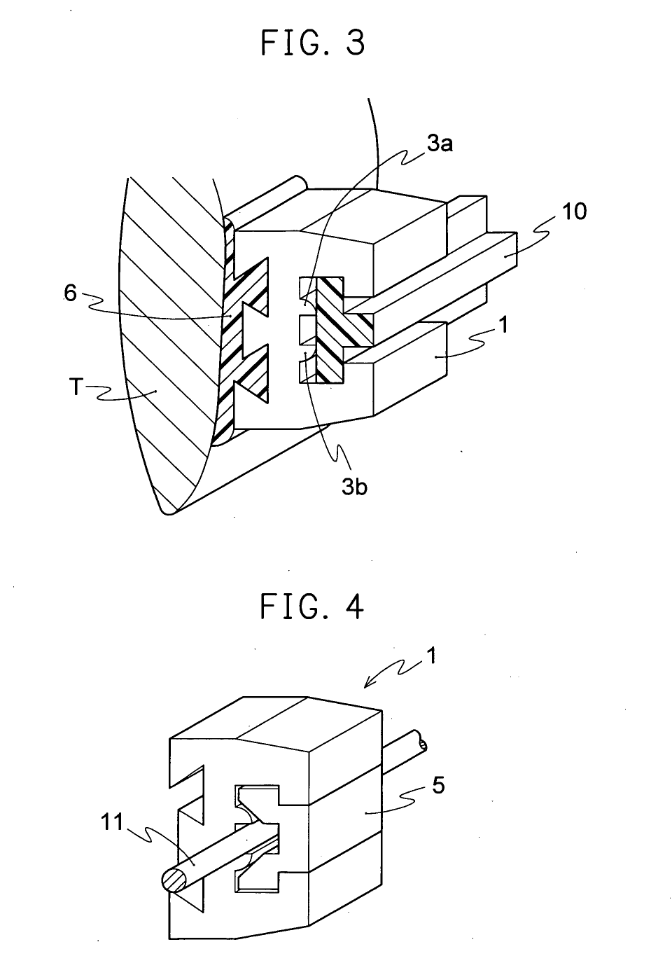

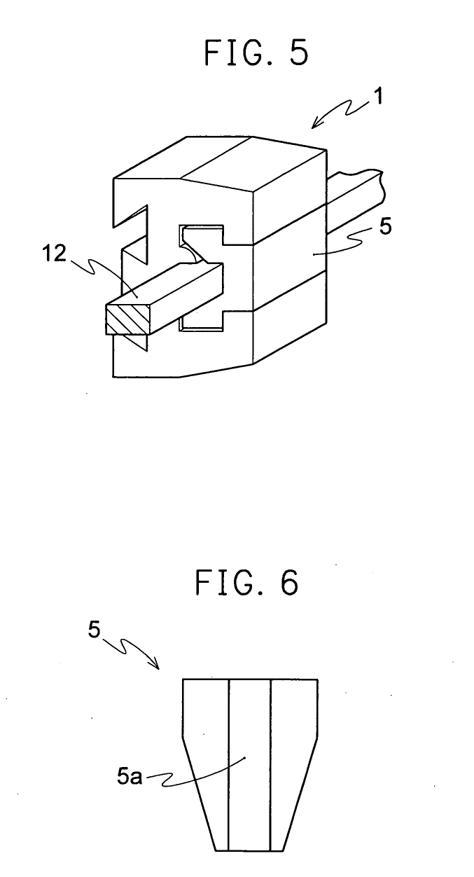

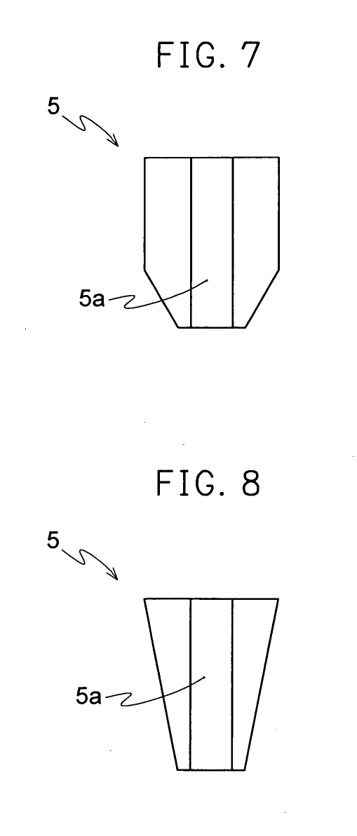

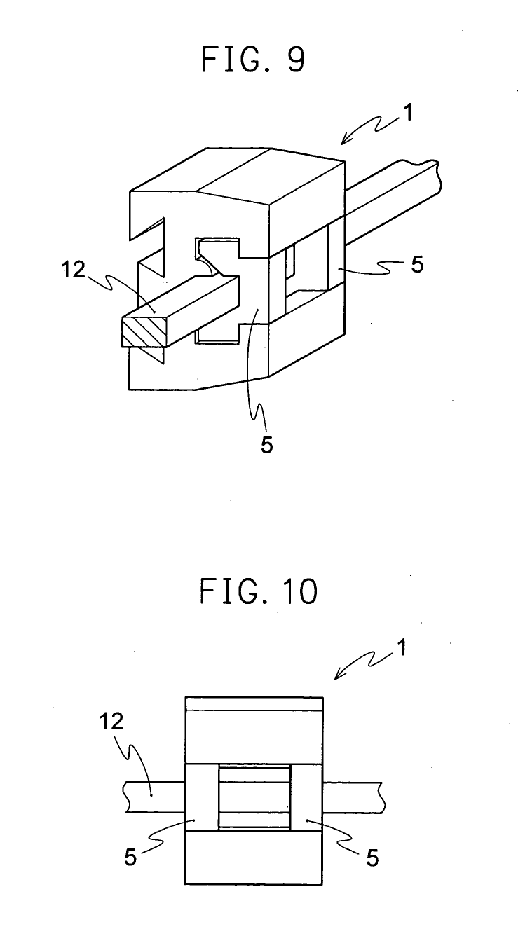

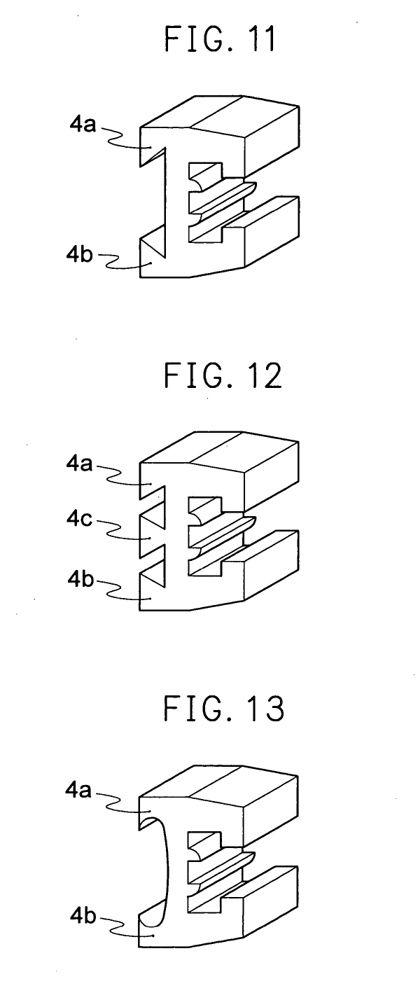

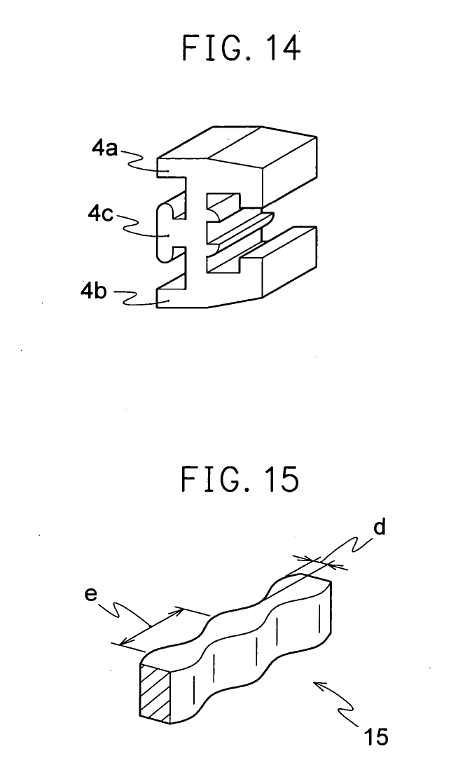

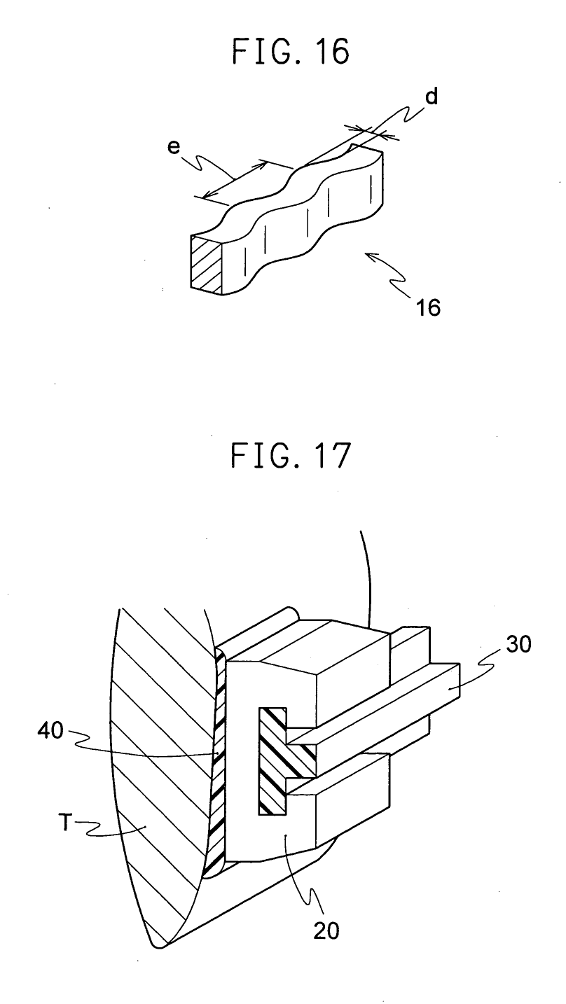

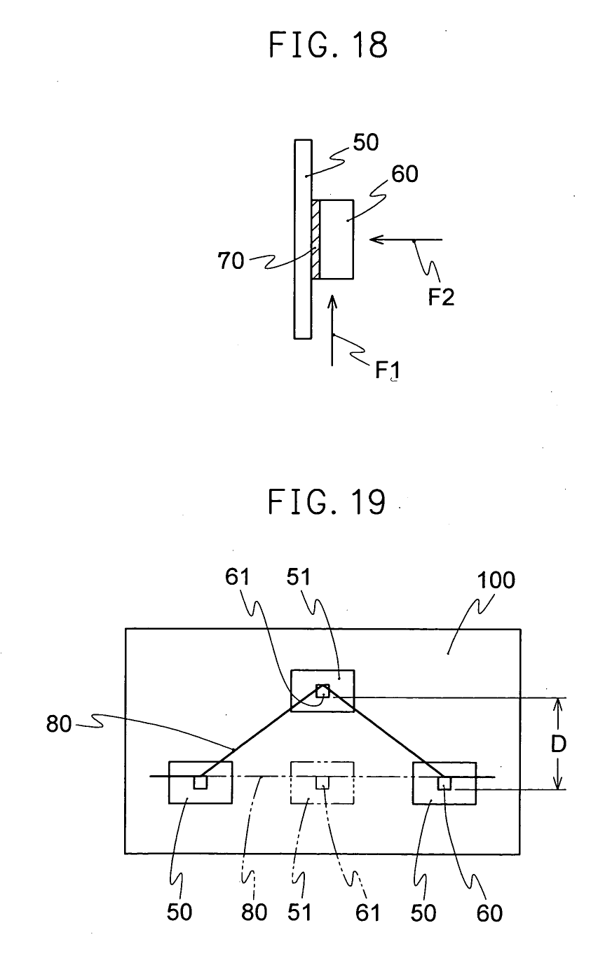

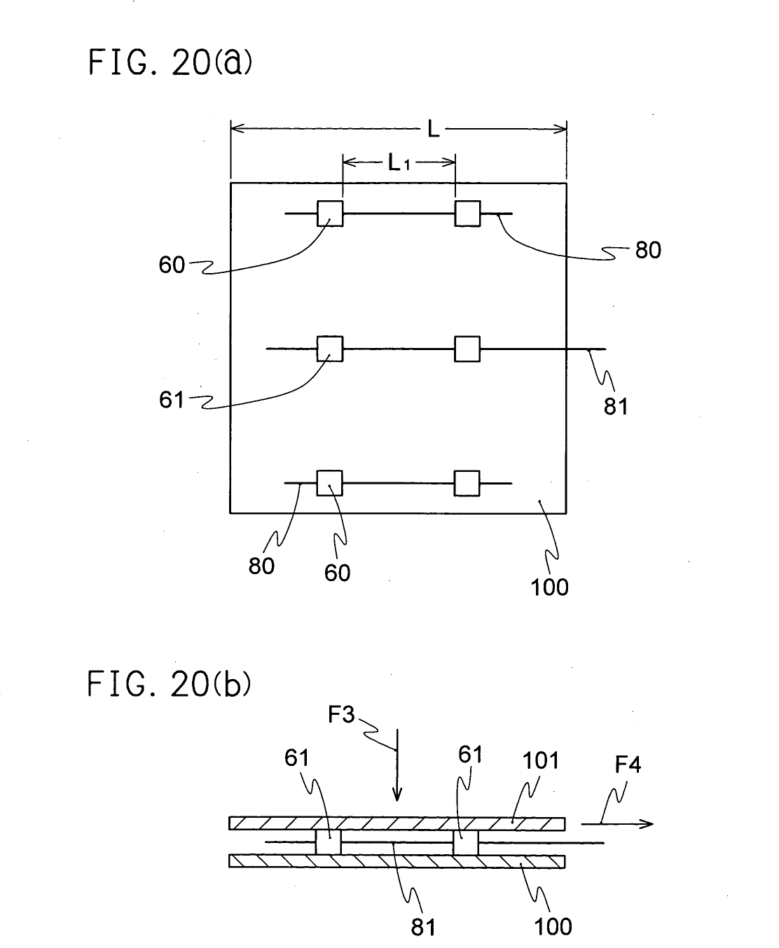

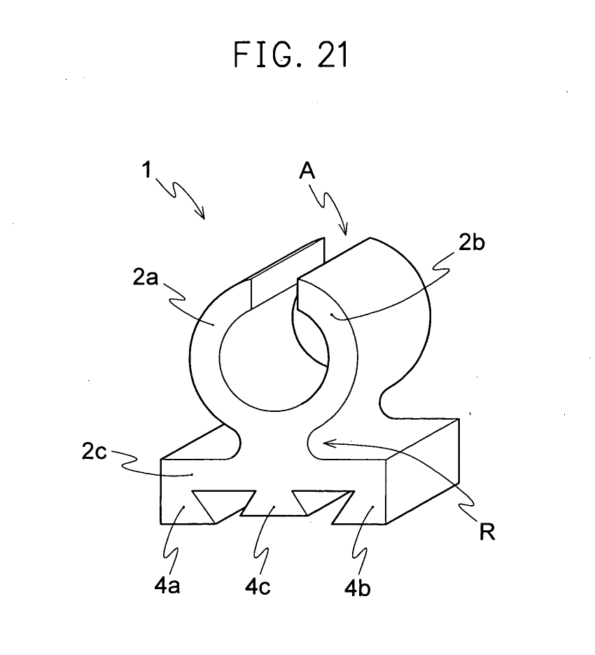

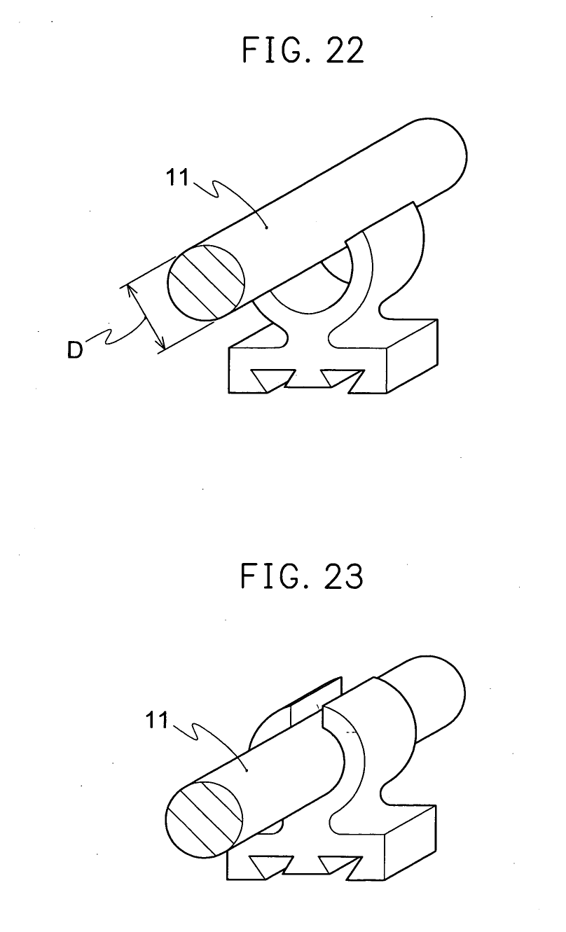

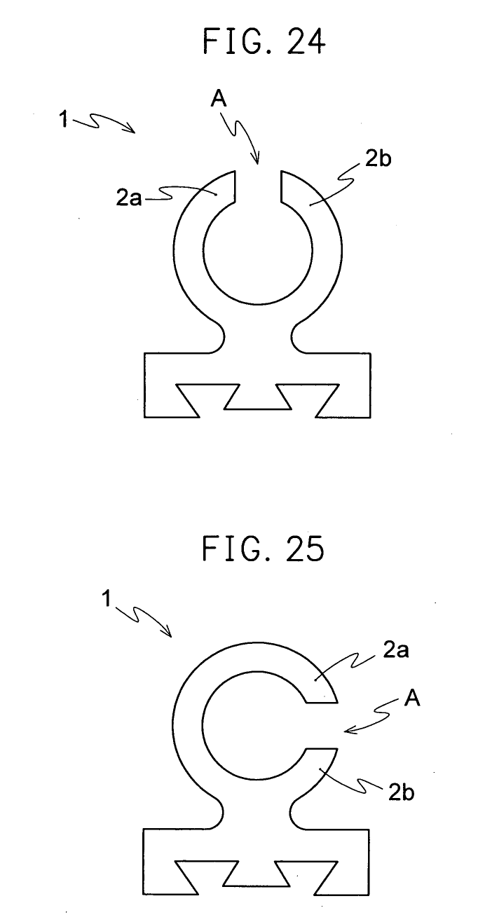

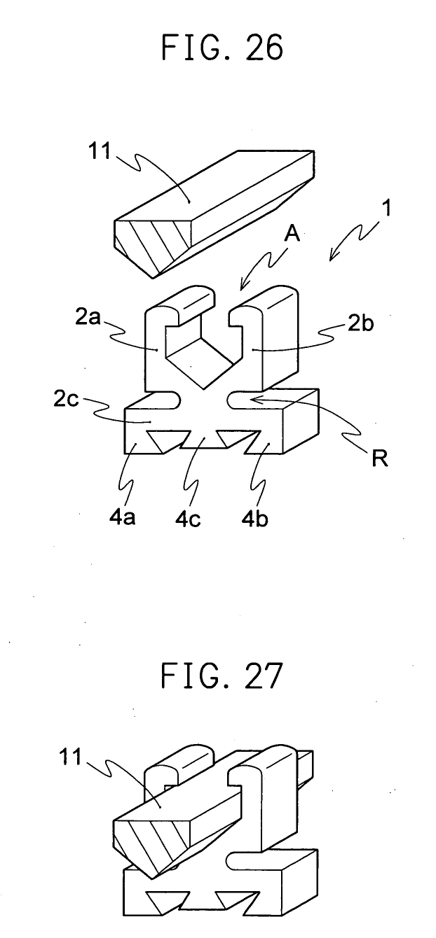

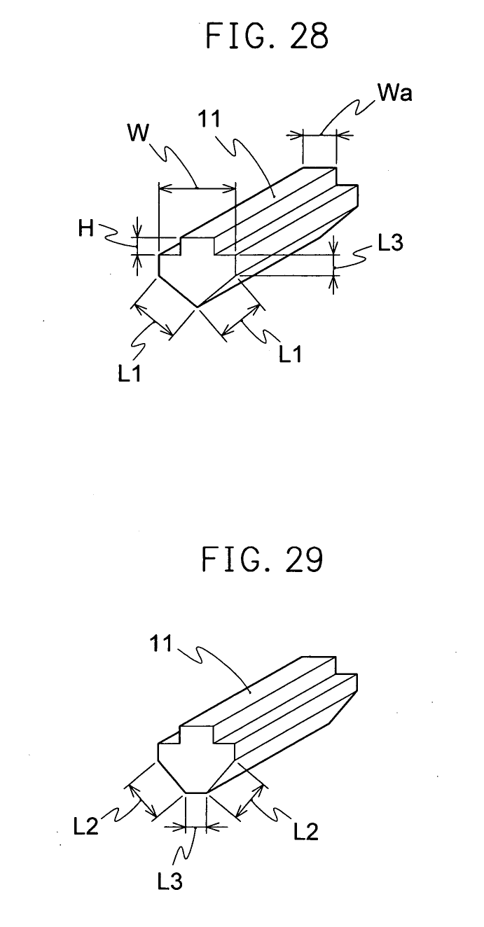

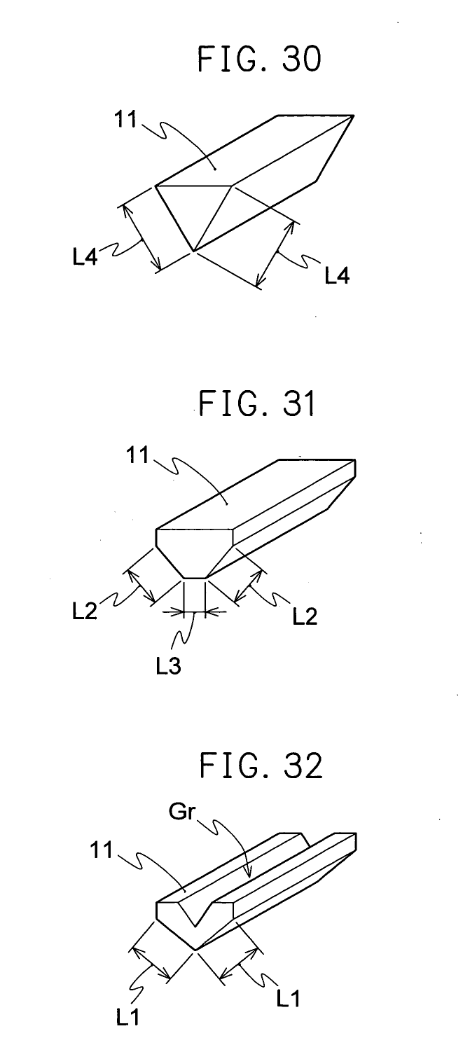

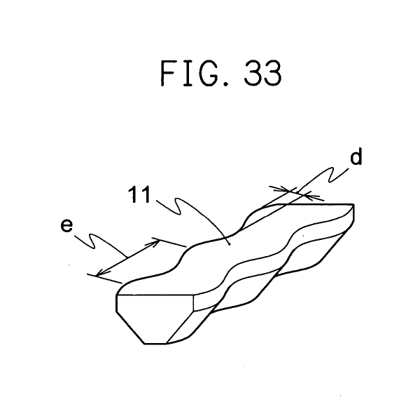

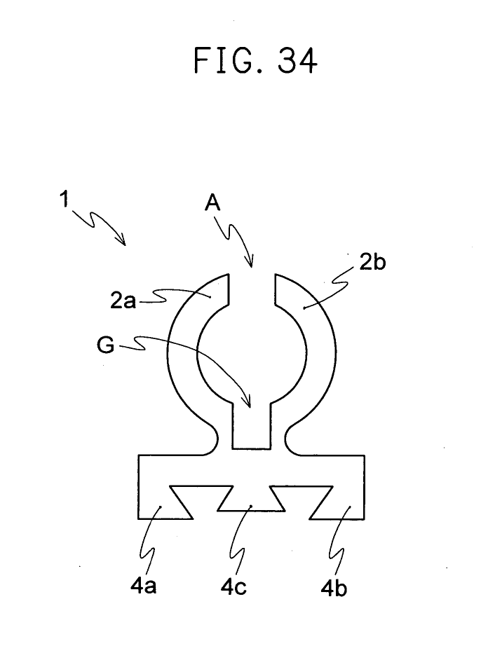

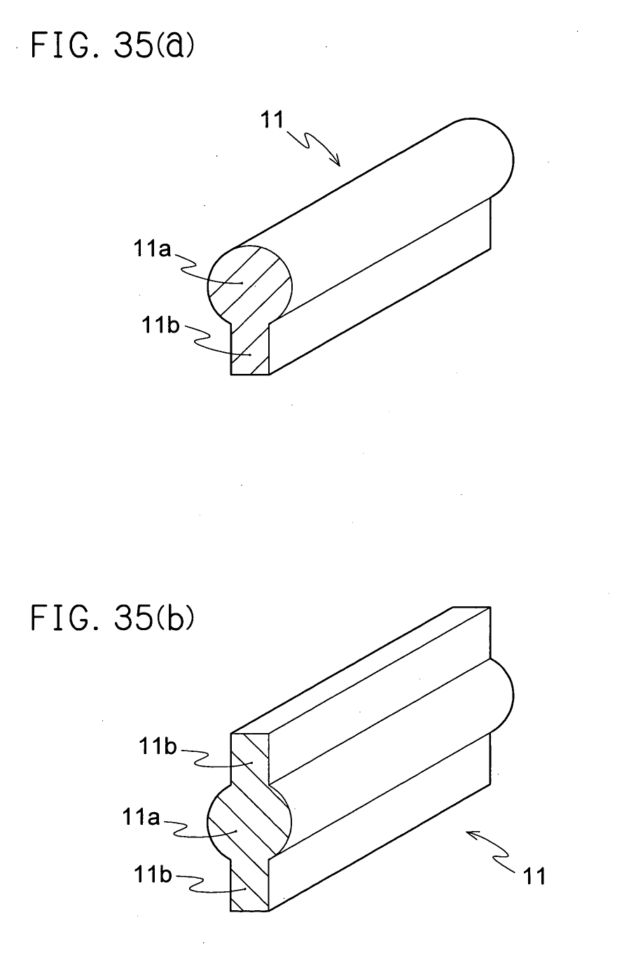

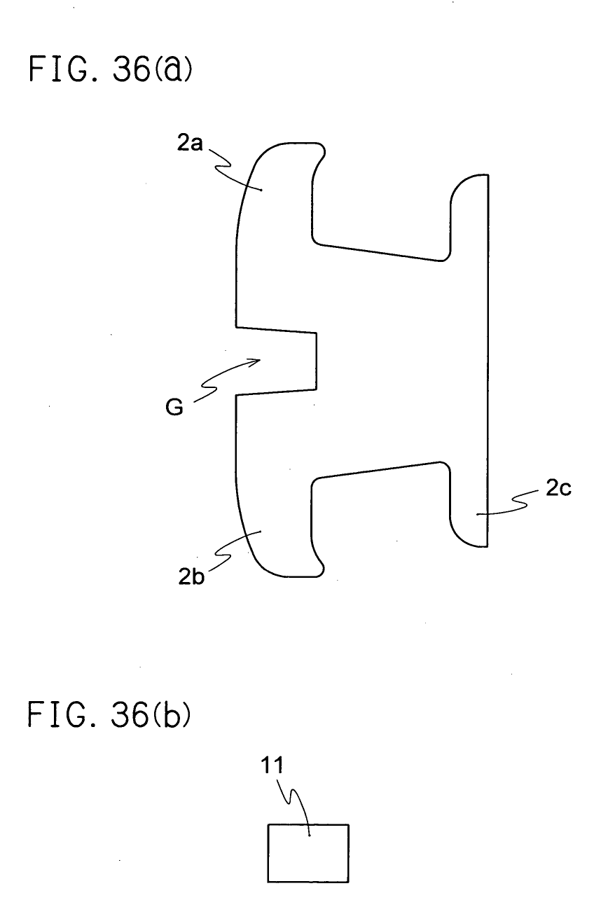

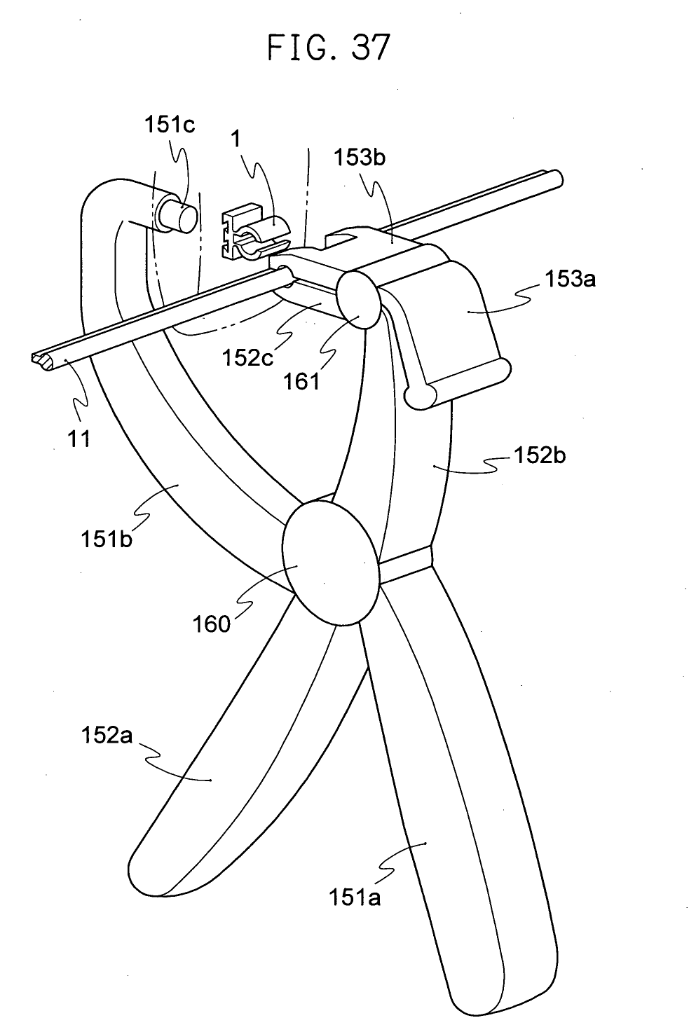

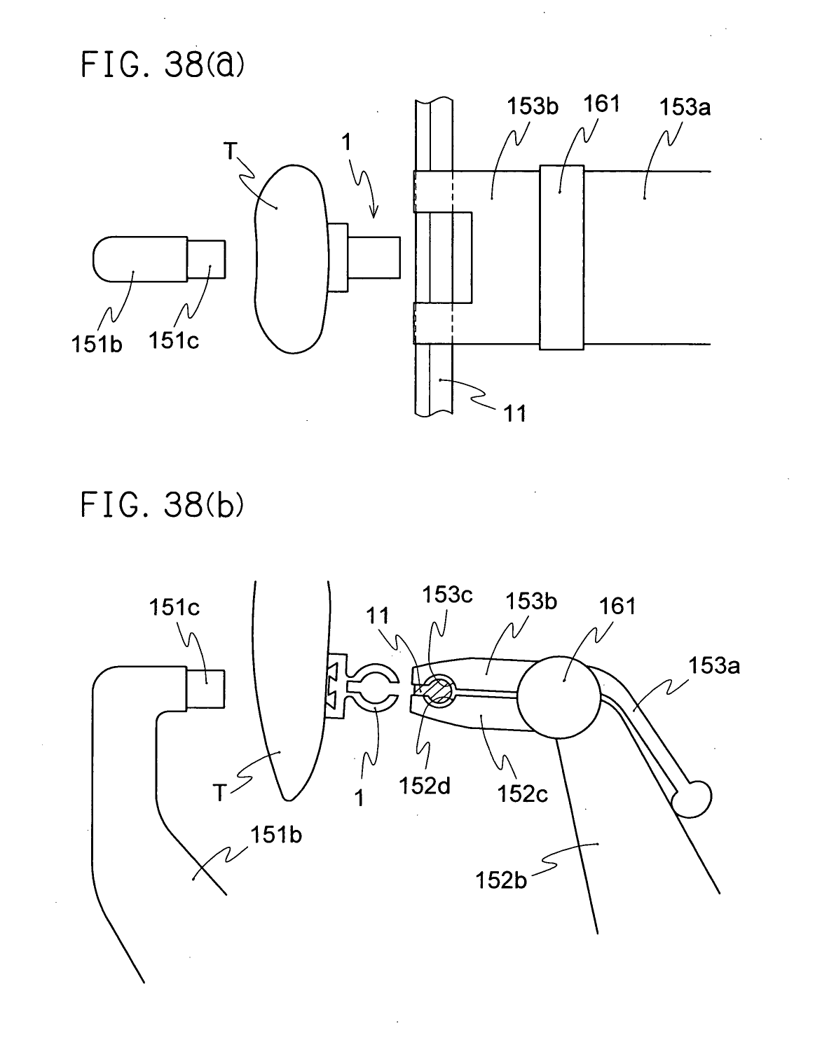

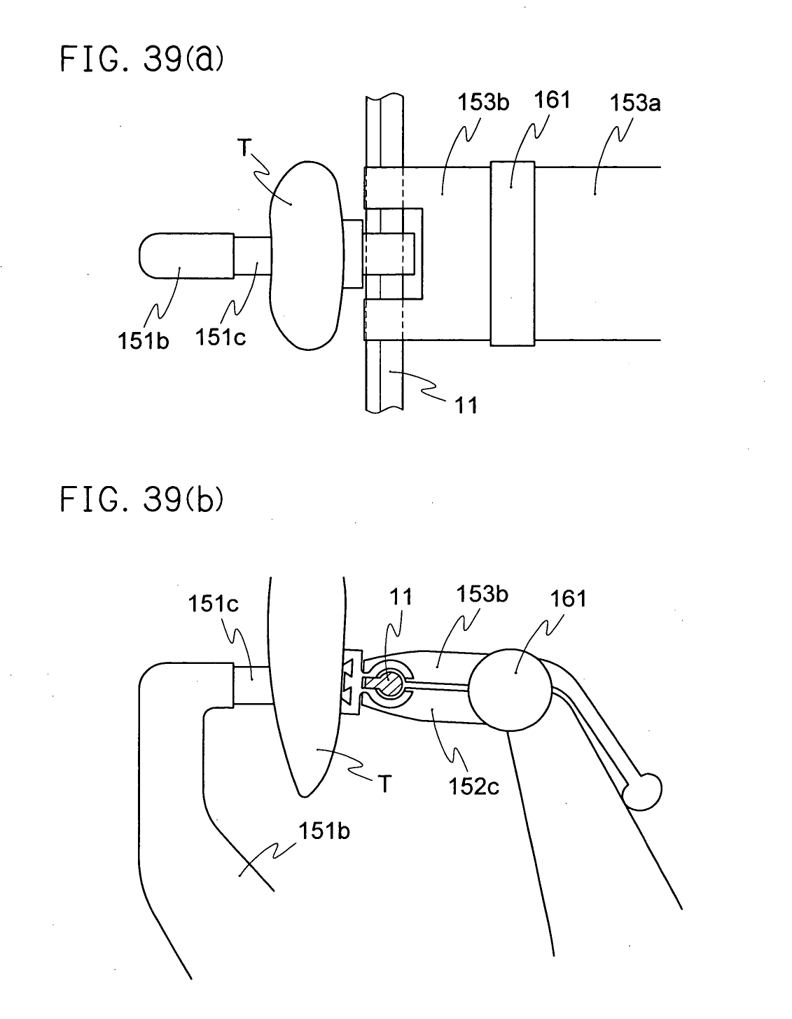

FIG. 1 is a perspective view illustrating an orthodontic bracket according to one embodiment of the present invention. FIG. 2 is a perspective view illustrating a stopper according to another embodiment of the present invention. FIG. 3 is an explanation drawing illustrating the orthodontic bracket of FIG. 1 attached to a tooth surface, onto which an arch wire having a T-shape cross section has been mounted. FIG. 4 is an explanation drawing illustrating the orthodontic bracket of FIG. 1 onto which an arch wire having a round cross section and a stopper have been mounted. FIG. 5 is an explanation drawing illustrating the orthodontic bracket of FIG. 1 onto which an arch wire having a rectangular cross section and a stopper have been mounted. FIG. 6 is a plan view illustrating a modification of the stopper of FIG. 2. FIG. 7 is a plan view illustrating another modification of the stopper of FIG. 2. FIG. 8 is a plan view illustrating a further modification of the stopper of FIG. 2. FIG. 9 is a perspective view illustrating another example of the stopper, which has been mounted on the orthodontic bracket of FIG. 1 according to one embodiment of the present invention and an arch wire. FIG. 10 is a front view of the stopper of FIG. 9. FIG. 11 is a perspective view illustrating an example of an orthodontic bracket according to an alternative embodiment of the present invention. FIG. 12 is a perspective view illustrating another example of the orthodontic bracket according to the alternative embodiment of the present invention. FIG. 13 is a perspective view illustrating a further example of the orthodontic bracket according to the alternative embodiment of the present invention. FIG. 14 is a perspective view illustrating a further example of the orthodontic bracket according to the alternative embodiment of the present invention. FIG. 15 is a perspective view illustrating an example of an orthodontic bracket according to a further alternative embodiment of the present invention. FIG. 16 is a perspective view illustrating another example of the orthodontic bracket according to the further alternative embodiment of the present invention. FIG. 17 is an explanation view illustrating a conventional orthodontic bracket, onto which an arch wire has been mounted. FIG. 18 is an explanation view illustrating a peel strength test method. FIG. 19 is an explanation view illustrating a destructive strength test method. FIG. 20(a) is an explanation view illustrating a followability test method. FIG. 20(b) is an explanation view illustrating a slippage test method. FIG. 21 is a perspective view illustrating a further example of the orthodontic bracket according to the further alternative embodiment of the present invention. FIG. 22 is an explanation view illustrating the orthodontic bracket of FIG. 21 and an arch wire just before the arch wire is mounted onto the orthodontic. FIG. 23 is an explanation view illustrating the orthodontic bracket of FIG. 21 and the arch wire wherein the arch wire has been mounted onto the orthodontic. FIG. 24 is a cross sectional explanation view of the orthodontic bracket of FIG. 21. FIG. 25 is a cross sectional explanation view illustrating a modification of the orthodontic bracket of FIG. 21. FIG. 26 is a perspective view illustrating an orthodontic bracket according to a further alternative embodiment of the present invention and an arch wire just before the arch wire is mounted onto the orthodontic bracket. FIG. 27 is an explanation view illustrating the orthodontic bracket of FIG. 26 onto which the arch wire has been mounted. FIG. 28 is an explanation view illustrating a modification of the arch wire which is applied to the orthodontic bracket of FIG. 26. FIG. 29 is an explanation view illustrating another modification of the arch wire which is applied to the orthodontic bracket of FIG. 26. FIG. 30 is an explanation view illustrating a further modification of the arch wire which is applied to the orthodontic bracket of FIG. 26. FIG. 31 is an explanation view illustrating a further modification of the arch wire which is applied to the orthodontic bracket of FIG. 26. FIG. 32 is an explanation view illustrating a further modification of the arch wire which is applied to the orthodontic bracket of FIG. 26. FIG. 33 is an explanation view illustrating a further modification of the arch wire which is applied to the orthodontic bracket of FIG. 26. FIG. 34 is a cross sectional explanation view illustrating a modification of the orthodontic bracket of FIG. 21. FIG. 35 is a perspective view illustrating an arch wire which is applied to the orthodontic bracket of FIG. 34. FIG. 36 is a cross sectional explanation view illustrating a conventional orthodontic bracket and an arch wire which is applied to this orthodontic bracket. FIG. 37 is a perspective view illustrating pliers for mounting the arch wire of FIG. 35 onto the bracket of FIG. 34. FIG. 38 is an explanation view illustrating a method for mounting an arch wire onto a bracket utilizing the pliers of FIG. 37. FIG. 39 is an explanation view illustrating the method for mounting an arch wire onto a bracket utilizing the pliers of FIG. 37.

### EMBODIMENT 1

An orthodontic bracket (hereinafter, referred to as “bracket”) 1 illustrated in FIG. 1 includes a base 2c which is secured to a tooth T (see, FIG. 3) and claws 2a, 2b having a L-shape cross section, which are protruded from the upper and lower ends of the base 2c such that they are faced to each other. The base 2c and the claws 2a, 2b constitute a wire engaging slot A having a T-shape cross section. Fixed spacers 3a, 3b are provided on the bottom of the wire engaging slot A (namely, the portion of the base 2c which lies between the claws 2a, 2b). The bracket 1 is made of the same material as that of the aforementioned conventional bracket.

Referring to FIG. 1, the fixed spacers 3a, 3b are shown as continuous line-shaped (or protruded strip) protrusions, however, they are not limited to this configuration and may be configured from combinations of several pillars or pillars and protruded strips.

The “line-shaped protrusions” provided on the inside bottom of the bracket 1 as illustrated in FIG. 1 further reduces the friction between the bracket 1 and an arch wire 10 (see FIG. 3), which may greatly improve the slippage of the arch wire 10 as compared with the conventional bracket 20 of FIG. 17. As a result, periods required for orthodontic treatment can be shortened. This is because the bottom surface of the arch wire 10 rests on the protruded lines at the tip ends of the fixed spacers 3a, 3b, and therefore there is significantly reduced contact area between the arch wire 30 and the bracket 20 thereby greatly enhancing the slippage of the arch wire, while the arch wire 30 and the bracket 20 have been in surface contact as illustrated in FIG. 17 in the prior art.

By setting the spacing between the fixed spacers 3a, 3b to approximately 0.25 to 0.75 mm (namely, a width of 0.01 to 0.03 inch), conventionally used arch wires having a round or rectangular cross section can be applied to the bracket 1 according to the present embodiment, as well as the arch wire 30 having a convex-cross section (see FIG. 17) which has been used in conventional orthodontic apparatuses. The height of the spacers 3a, 3b is preferably set to 10 to 150% of the height of an arch wire 5 having a rectangular cross section (see FIG. 5). When an arch wire 10 having a convex-cross section (see FIG. 3) is used, ligaturing is not required as in the prior art. However, when an arch wire 11 having a round cross section (see FIG. 4) or an arch wire 12 having a rectangular cross section (see FIG. 5) is used, the arch wire can be ligatured with a ligaturing wire or module rubber, by providing protrusions N for ligaturing as illustrated in FIG. 1 on the bracket 1.

### EMBODIMENT 2

According to the present embodiment, as illustrated in FIGS. 4 and 5, a movable spacer 5 including two legs 5b, 5b and a coupling portion 5a coupling the two legs 5b, 5b is movably inserted through the above engaging slot A. As illustrated in FIGS. 4 and 5, when the movable spacer 5 is inserted into the engaging slot A, the movable spacer is placed in the engaging slot such that the two legs 5b, 5b straddle the fixed spacers 3a, 3b and at least the outer surfaces of the legs 5b, 5b are in contact with the inside surfaces of the claws 2a, 2b of the bracket (see FIGS. 4 and 5). In other words, preferably, the gap between the tip ends of the above two claws 2a, 2b is blocked with the coupling portion 5a, and the space between the root portions of the claws 2a, 2b other than the fixed spacers 3a, 3b and the arch wire is substantially blocked with the legs 5b, 5b (namely, almost all the space other than the space required for inserting an arch wire having a round or rectangular cross section is occupied by the stopper 5).

Accordingly, there is an advantage that even when an arch wire having a round or rectangular cross section is used, there is no need for ligaturing since the space of the bracket 1 is occupied by the arch wire by sliding it laterally into the bracket 1 from the side surface. Moreover, since there is no need for ligaturing with a ligaturing wire or module (there is no need to ligature the arch wire to the bracket), there is no friction between the arch wire having a round cross section and ligaturing wires and therefore the slippage is enhanced, which will provide an advantage of shortening treatment periods. Also, when an arch wire having a rectangular cross section is used, there is, of course, no friction between the arch wire and ligaturing wires, and also there is no play space between the rectangular cross section of the arch wire and the wall surfaces of the movable spacer and the bracket. Therefore, in producing a torque by twisting the arch wire having a rectangular cross section, the torque can be sufficiently produced.

Namely, the stopper according to the present embodiment occupies most of the space other than the portion of the fixed spacers for securing the arch wire within the bracket 1, and therefore the bracket becomes, so to say, one plastic block.

As a result, the strength of the bracket is greatly enhanced, resulting in drastic reduction of breakage of the bracket. The depth of the recess 5c of the movable spacer 5 is preferably set to 10 to 150% of the height of the arch wire 12 having a rectangular cross section (see FIG. 5). The height of the space formed between the fixed spacers 3a, 3b of the bracket 1 and the movable spacer 5, which is for mounting the arch wire 12 having a rectangular cross section, is preferably set to 100 to 150% of the height of the arch wire 12 having a rectangular cross section. The lateral width of the space formed between the fixed spacers 3a, 3b of the bracket 1 and the movable spacer 5, which is for mounting the arch wire 12 having a rectangular cross section, is preferably set to 100 to 150% of the lateral width of the arch wire 12 having a rectangular cross section. Further, the length of the movable spacer 5 is preferably set to 50 to 150% of the length of the bracket 1.

Referring to FIGS. 6 to 8, the movable spacer 5 is shaped to include an end which is partially or entirely narrower than the width of the bracket 1 and the opposite end having a width which is equal to or slightly larger than the width of the bracket 1 (100 to 150% of the width of the bracket). With this shape of the movable spacer 5, when the movable spacer 5 is slid laterally into the bracket 1 with the narrower end in the lead, the width of the opposite end of the stopper is brought into contact with the inside side surface of the bracket, and at a certain position the stopper is prevented from being inserted more deeply. Therefore, once inserted into the bracket 1, the movable spacer will not be easily disengaged in the bracket 1. When the movable spacer is to be disengaged, it can be disengaged by extruding in the direction opposite to the direction in which it was inserted.

### EMBODIMENT 3

As illustrated in FIG. 11, the bracket of the present embodiment has undercuts constituted by two legs 4a, 4b each having a substantially dovetail cross section and formed at the position which is faced to the surface of a tooth. The undercuts may have curved surfaces such as partial cylindrical surfaces as illustrated in FIG. 13 or elliptic surfaces, instead of the tapered surfaces of the legs 4a, 4b having a dovetail cross section of FIG. 11. Also, an additional leg 4c having a dovetail cross section may be provided between the legs 4a, 4b having a dovetail cross section (see FIG. 12). The number of the additional leg 4c having a dovetail cross section may be one or more than one. Also, as illustrated in FIG. 14, the undercuts may be formed from rectangular cylinders 4a, 4b and a member 4c formed from a combination of a rectangular cylinder and a substantially elliptic cylinder or circular cylinder.

The undercuts allows the bracket to have a cuneiform physical bonding force, which greatly enhances the bonding force at the portions of the bracket 1 which are bonded to a tooth surface. Of course, an uneven formation, such as small embossment, is included in the concept of above-mentioned undercut.

### EMBODIMENT 4

The present embodiment is an arch wire 15 (see FIG. 15) and an arch wire 16 (see FIG. 16) which are inserted into the brackets 1 according to the first to the third embodiments.

The arch wires 15, 16 according to the present embodiment have waveform curved surfaces W formed at the portions which, when the arch wire is inserted into the bracket 1, contact the inside surfaces of the claws 2a, 2b of the bracket 1. Accordingly, the contact area between the bracket 1 and the arch wire 15 or 16 can be reduced, and the slippage of the arch wire 15 or 16 can be improved.

When a conventional arch wire (namely, an arch wire having a wide bottom) is used in early stages of treatment where the teeth alignment has not been corrected, the arch wire may experience excessive bending stresses and be deformed since the arch wire can not sufficiently follow large bending, which may cause the arch wire to lose its elasticity or to break. However, by providing waveform curved surfaces W at the portions which contact the inside surfaces of the bracket 1, as the arch wires according to the present embodiment, an arch wire configured to have a partially narrowed width can be realized. The portions having a narrower width in the arch wire of the present embodiment will experience lower stresses (namely, by providing the waveform curved surfaces W at the side surfaces of the arch wire, portions which will experience lower stresses can be provided in advance). Further, even if an deviation between adjacent brackets 1 occurs at any portion of the arch wire, there are necessarily portions which experience lower stresses, and therefore the arch wire is prevented from deforming. Therefore, the arch wire is prevented from breaking or deforming in early stages of treatment where teeth alignment has not yet been corrected. Moreover, the slippage of the arch wire is enhanced resulting in shortened treatment periods. The spacing e between the waves is preferably set to 5 to 200% of the spacing of adjacent brackets 1 and the depth d of the waves is preferably set to 5 to 80% of the width of the orthodontic wire.

While the present invention will be explained in detail with embodiments thereof hereinafter, the present invention is not limited to them.

### EMBODIMENT 5

As illustrated in FIG. 21, a synthetic resin orthodontic bracket 1 (hereinafter, referred to as “bracket”) according to the present embodiment includes base 2c which is secured to a tooth and claws 2a, 2b extending from the base 2c and curved into an arc-shape. The claw 2a and the claw 2b are faced to each other across the slot A and have a substantially tubular entire shape. Also, as illustrated in FIG. 21, constricted portions R are formed near the root portions of the claws 2a, 2b. Further, as illustrated in FIG. 21, dovetail-shaped undercuts 4a, 4b and 4c are formed on the surface of the base 2c which is opposite the surface on which the claws 2a, 2b are formed. Of course, an uneven formation, such as small embossment, is included in the concept of above-mentioned undercut.

When a metal orthodontic arch wire 11 having a round cross section as illustrated in FIG. 22 is pressed against the slot A of the bracket 1 configured as described above according to the present embodiment, the above constricted portions R are deflected, and thus the slot A is widened by a small force (see FIG. 22). Accordingly, the metal arch wire 11 can be easily mounted to the bracket 1 as illustrated in FIG. 23.

In the bracket 1 according to the present embodiment, since the width of the slot A (namely, the distance between the tip end of the claw 2a and the tip end of the claw 2b) is smaller than the diameter D of the metal arch wire 11., the metal arch wire 11 will not get disengaged from the bracket 1 unless it is forcibly disengaged by a strong force or detached by sliding laterally, and also there is no need for ligaturing. The width of the slot A is preferably set to 10 to 90% of the diameter D of the metal arch wire 11.

The slot A is not required to be positioned at the center of the bracket 1 as illustrated in FIG. 24. For example, the arch wire engaging slot A may be provided at the position illustrated as a modification in FIG. 25.

As the metal arch wire 11 applied to the bracket of the present embodiment, an arch wire of any size (namely, diameters of 0.012 to 0.018 inch) which is generally employed for orthodontic applications may be used.

### EMBODIMENT 6

As illustrated in FIG. 26, a synthetic resin orthodontic bracket (hereinafter, referred to as “bracket”) 1 according to the present embodiment includes base 2c which is secured to a tooth and claws 2a, 2b extending from the base 2c and bent. The claws 2a, 2b are faced to each other across the slot A and have a substantially rail-form entire shape. Also, as illustrated in FIG. 26, constricted portions R are formed near the root portions of the claws 2a, 2b. Further, as illustrated in FIG. 26, dovetail-shaped undercuts 4a, 4b and 4c are formed on the surface of the base 2c which is opposite the surface on which the claws 2a, 2b are formed. Of course, an uneven formation, such as small embossment, is included in the concept of above-mentioned undercut.

When a cuneiform synthetic resin arch wire 11 as illustrated in FIGS. 26, 28 to 33 is pressed against the slot A of the bracket 1 configured as described above according to the present embodiment, the above constricted portions R are deflected, and thus the slot A is widened by a small force. Accordingly, the synthetic resin arch wire 11 can be easily mounted to the bracket 1 as illustrated in FIG. 27. According to the present embodiment, similarly to the fifth embodiment, the synthetic resin arch wire 11 is prevented from being disengaged from the bracket 1, and there is no need for ligaturing. The width of the slot A is preferably set to 10 to 90% of the width W (see FIG. 28) of the arch wire 11.

The shapes of the cross sections of the arch wires 11 in FIGS. 28, 29 are combinations of a cuneiform shape and a rectangular shape and the values of L1, L2, L3, H and Wa in FIGS. 28, 29 are respectively 0.1 to 1.5 mm, 0.1 to 1.5 mm, 0.1 to 1.5 mm, 0.1 to 1.5 mm and 0.1 to 1.5 mm. The value of Wa may be any value smaller than the width of the slot A (namely, the distance between the tip end of the claw 2a and the tip end of the claw 2b). Also, the shapes of the cross sections of the arch wires 11 in FIGS. 30, 31 are cuneiform shapes and the values of L2, L3 and L4 in FIGS. 30, 31 are respectively 0.1 to 1.5 mm, 0.1 to 1.5 mm and 0.1 to 1.5 mm. Also, the shape of the cross section of the arch wire 11 in FIGS. 32 is a combination of a cuneiform shape and a slot Gr having a V-shaped cross section and L1 is 0.1 to 1.5 mm.

The arch wire 11 in FIG. 33 has waveform curved surfaces formed at the opposite sides of the arch wire 11, as the arch wire 15 in FIG. 15. The spacing between the waves in the arch wire 11 is also preferably set to 5 to 200% of the spacing between adjacent brackets 1 and the depth d of the waves is preferably set to 5 to 80% of the width W of the arch wire 11. The arch wires 11 in FIGS. 28, 29 and 32 may also have waveform surfaces formed at the opposite sides thereof.

### EMBODIMENT 7

The bracket and the arch wire according to the aforementioned fifth embodiment were not provided in contemplation of twisting the arch wire for rotating the bracket (namely, imposing a torque on the bracket). Namely, the bracket and the arch wire according to the fifth embodiment are intended for mild cases. Currently, in the case where a torque must be produced, a conventionally known bracket 1 (FIG.36 (a)) and arch wire 11 (FIG. 36(b)) illustrated in FIGS. 36(a) and (b) are employed. The arch wire 11 is required to be ligatured after it has been inserted into a slot G in the bracket 1, in order to secure the arch wire 11 to the bracket 1. The bracket according to the present embodiment is a modification of the fifth embodiment and includes a slot G formed at the portion where the claws 2a, 2b of the bracket 1 are bonded. While the slot G has a rectangular cross section in the example illustrated in FIG. 34, the shape of the cross section of the slot G is not limited to a rectangular shape and may be any shape which can restrain the rotation of the arch wire 11, including shapes other than rectangular shapes such as elliptic shapes, triangles, polygons, etc. The depth and the width of the slot G may be any values within the range of from 10 to 90% of the diameter of the arch wire 11. On the other hand, as illustrated in FIGS. 35(a) and (b), the arch wire 11 of the present embodiment includes a protruded strip 11b which can be fitted in the slot G of the bracket 1, and the protruded strip 11b is integrally formed in the longitudinal direction of the cylindrical body 11a. As the shape of the cross section of the arch wire 11, a substantially square-front round-rear shape (FIG. 35(a)) or a substantially φ-shape (FIG. 35(b)) is preferably employed because of ease of manufacturing and ease of mounting onto the bracket 1. However, the shape of the cross section of the arch wire 11 is not limited to these shapes and may be any shape complementary to the above slot G in the bracket 1. The height and the width of the protruded strip 11b may be any values within the range of 10 % to 90% of the diameter of the arch wire 11. As the material of the arch wire of the present embodiment, a metal or a synthetic resin is employed.

By maintaining the shape of a round arch wire in the arch wire of the present embodiment, it becomes possible to insert it only by pressing against the bracket 1 according to the seventh embodiment (FIG. 34) (without ligaturing). By providing the protruded strip at a portion of the arch wire, it becomes possible to produce a torque by inserting the protruded strip into the slot formed in the same bracket 1 (FIG. 34). The bracket according to the seventh embodiment, which is a bracket on which a torque can be imposed, is not required to be ligatured and therefore includes no wing for ligaturing. Further, this bracket is not required to have a large thickness since it is possible to impose a torque thereon by fitting the protrusion of the wire with the protruded strip in the slot, while existing brackets must have a large thickness in order to have a sufficient strength for, when a torque is imposed, withstanding the force of the torque. Therefore, this bracket may have a smaller shape than the existing bracket 1 (FIG. 36(a)), thereby reducing uncomfortable feeling in the mouth. As a result, the entire orthodontic apparatus can impose a reduced burden on the patient, and also the bracket will be inconspicuous when mounted onto a tooth.

Next, with reference to FIG. 37, pliers for mounting the arch wire of the present embodiment onto the bracket will be explained. The pliers according to the present embodiment include pliers-opening/closing grips 151a, 152a, a tooth-backside pressing arm 151b formed integrally with the pliers-opening/closing grip 151a, and an arch-wire pressing arm 152b formed integrally with the pliers-opening/closing grip 152a. The pliers-opening/closing grips 151a and 152a, the tooth-backside pressing arm 151b and the arch-wire pressing arm 152b are assembled into an X-shape through a shaft 160 and are pivotable about the shaft 160. Also, through a shaft 161 provided at the tip end of the tooth-backside pressing arm 152b, the pliers include an arch-wire-fixing-blade operating lever 153a and an arch-wire fixing blade 153b formed integrally with the arch-wire-fixing-blade operating lever 153a, and an arch-wire fixing blade 152c formed integrally with the arch-wire pressing arm 152b. The arch-wire-fixing-blade operating lever 153a and the arch-wire fixing blade 153b are pivotable about the shaft 161. The arch-wire fixing blades 152c, 153b have protruded right and left ends, each including a recesses 152d, 153c for inserting an arch wire. Further, a cushion 151c is provided at the tip end of the tooth-backside pressing arm 151b. As the material of the cushion 151c, rubber or polyurethane, for example, is employed. However, the material of the cushion 151c is not limited to them and may be any elastic material.

With such characteristics in the configuration of the pliers according to the present embodiment, the arch wire can be mounted onto the bracket without imposing a burden on a tooth.

Next, with reference to FIGS. 38 and 39, a method for mounting the arch wire of the present embodiment onto the bracket will be explained.

At first, the arch wire is held with the recesses 152d and 153c for inserting the arch wire.

The wire fixing-blade-operating lever is pivoted in the clockwise direction about the shaft 161 (see FIG. 39(b)) to fix the arch wire with respect to the arch-wire fixing blades 152c, 153b.

Subsequently, the cushion 151 c is brought into contact with the backside of a tooth by grasping the pliers-opening/closing-grips 151a, 152a.

Then, the arch wire 11 is brought into contact with the bracket 1 such that the bracket 1 lies between the tip ends of the right and left ends of the arch-wire fixing blades 152c and 153d and also the opening of the bracket 1 and the arch wire 11 are in parallel.

As a method for holding the arch wire, there are various methods for holding the arch wire in a constant direction other than the aforementioned method. Various modifications and variations are apparent to those skilled in the art and these are included in the present invention.

Then, the pliers-opening/closing grips 151a, 152a are grasped to mount the arch wire 11 onto the bracket 1.

The wire-fixing-blade operating lever is pivoted in the counter-clockwise direction about the shaft 161 to open the tip ends of the arch-wire fixing blades 152c, 153c to disengage the arch wire 11 from the arch-wire fixing blades 152c, 153b. Also, the pliers according to the present embodiment can be utilized in mounting the arch wire 11 illustrated in FIG. 22 onto the bracket 1 illustrated in FIG. 21.

### EXAMPLE 1

A bracket 60 including the undercut according to claim 5 was fabricated by injection molding using polycarbonate as the material. As illustrated in FIG. 18, the bracket 60 was attached to a ceramic plate 50 by applying a dental adhesive (chemical polymer resin) 70 to the base of the bracket 60.

Then, the bracket 60 was subjected to a force F1 parallel to the ceramic plate 70 and the force when the bracket 60 separated from the ceramic plate 70 (peel force) was measured. Similarly, a conventional bracket (FIG. 17) having no undercut was attached to the ceramic plate 70 by applying a dental adhesive to the base of the bracket. Then, the conventional bracket was subjected to the force F1 and the force when the bracket separated from the ceramic plate 70 was measured.

The results of the measurements were as represented in Table. 1.

TABLE 1

| | Embodiment 1 | Prior Art |
|---|---|---|
| force (kgf) | 5.04 | 1.81 |

As apparent from Table. 1, it was proven that the bracket according to claim 5 having an undercut formed at the base thereof had an improved bonding force, as compared with the conventional bracket. As a result, when the bracket according to claim 5 is attached to a tooth surface, the bracket is significantly less prone to get disengaged from the tooth surface.

### EXAMPLE 2

Next, a bracket 60 including a movable spacer according to claim 4 was fabricated by injection molding using polycarbonate as the material. As illustrated in FIG. 18, the bracket 60 was attached to a ceramic plate 50 by applying a dental adhesive 70 to the base of the bracket 60.

Then, the bracket 60 was subjected to a force F2 normal to the ceramic plate 70 and the strength when the bracket 60 was broken (destructive strength) was measured. Similarly, the destructive strength of a bracket including no movable spacer was measured.

The results of the measurements were as represented in Table. 2.

TABLE 2

| | With a movable spacer | Without a movable spacer |
|---|---|---|
| Force (kgf) | 11.97 | 5.41 |

As apparent from Table. 2, the bracket including the movable spacer had much higher strength than that of the bracket having no movable spacer. Therefore, the bracket according to claim 4 is significantly less prone to be broken.

### EXAMPLE 3

An arch wire 80 including waveform curved surfaces according to claim 6 of the present invention was fabricated by injection molding using polycarbonate as the material.

Then, as illustrated in FIG. 19, two ceramic plates 50 each having a bracket 60 attached thereon were secured to a table 100. Subsequently, a ceramic plate 51 having a bracket 61 attached thereon were movably set between the secured two ceramic plates 50, and then an arch wire 80 were inserted through the three brackets. The spacing between adjacent brackets was set to 6 mm, which was an average interdental spacing. Then, the force of the arch wire 80 required for moving the movable ceramic plate 51 by a distance D (D=3 mm) (namely, the followability with respect to teeth deviation) was measured.

Similarly, for a conventional arch wire having a convex cross section, the force of the conventional arch wire required for moving the movable ceramic plate 51 by 3 mm was measured.

The results of the measurements were as represented in Table. 3.

TABLE 3

| | Embodiment 3 | Prior Art |
|---|---|---|
| force (gf) | 130 | 530 |

Generally, it is said that a tooth is moved by a force of approximately 100 gf. A tooth can be moved by approximately 3 mm maximum. Therefore, in order to move a tooth deviated by 3 mm, a force of about 100 gf is required. If an excessively large force is imposed, this may cause toothache and damaged tooth root. Further, if a large force is constantly imposed, the arch wire may be broken, or the bracket may be broken or disengaged from the tooth surface since a strong force of the wire is imposed on the inside of the bracket. The arch wire having waveform curved surfaces according to claim 6 can produce an appropriate force (100 gf) which is required for orthodontics and also can move smoothly without causing toothache, thereby drastically reducing breakage and disengagement of the bracket and breakage of the wire.

### EXAMPLE 4

Brackets 60, 61 including fixed spacers according to claim 1 of the present invention were fabricated by injection molding using polycarbonate as the material.

Then, as illustrated in FIG. 20(a) and FIG. 20(b), the brackets 61 were attached such that they were spaced apart by a distance of L1 (L1=2 cm), at the center of a square-shaped ceramic plate 100 with a side length of L (L=6 cm). Then, a convex-cross sectional arch wire 81 was movably set (FIG. 20(a)). Also, the brackets 60 were similarly attached above and below the center brackets 61 and a convex-cross sectional arch wires 80 were secured to the brackets 60 (FIG. 20(b)).

Then, as illustrated in FIG. 20(b), a ceramic plate 101 was placed on the top of the convex-cross section of the arch wires, which have the convex-cross section and is set as shown in FIG. 20(b). Then, the initial tensile stress force F4 was measured after moving the movable and convex-cross sectional arch wire 81 with a load of 500 g imposed thereon. Similarly, for prior-art brackets the insides of which were flat, the initial tensile stress force F4 after moving the movable and convex-cross sectional arch wire was measured.

The results of the measurements were as represented in Table. 4.

TABLE 4

| | Embodiment 4 | Prior Art |
|---|---|---|
| force F4 (Kgf) | 0.22 | 0.56 |

It was proven that the brackets including the fixed spacers at the insides thereof offered lower frictional resistance and higher slippage than the prior-art brackets. In order to move a tooth, the wire has to be slip within the bracket by the distance the tooth has to be moved. If there is large friction between the wire and the bracket, this will degrade the slippage, thus preventing the movement of the tooth and prolonging the treatment period. The bracket according to claim 1 offers enhanced slippage and therefore allows teeth to move smoothly.

### EXAMPLE 5

An arch wire having a rectangular cross section (see FIG. 36(b)), an arch wire having a front-rectangular-rear round shape cross section (see FIG. 35(a)) and an conventional arch wire having a round cross section were fabricated from stainless steel (SUS). Also, brackets fittable to the respective arch wires were fabricated from polycarbonate. As the bracket fittable to the arch wire having a rectangular cross section, the bracket wire illustrated in FIG. 1 was selected. As the bracket fittable to the arch wire having a front-rectangular-rear-round shape cross section, the bracket illustrated in FIG. 34 was selected. As the bracket fittable to the arch wire having a round cross section, the bracket illustrated in FIG. 1 was selected.

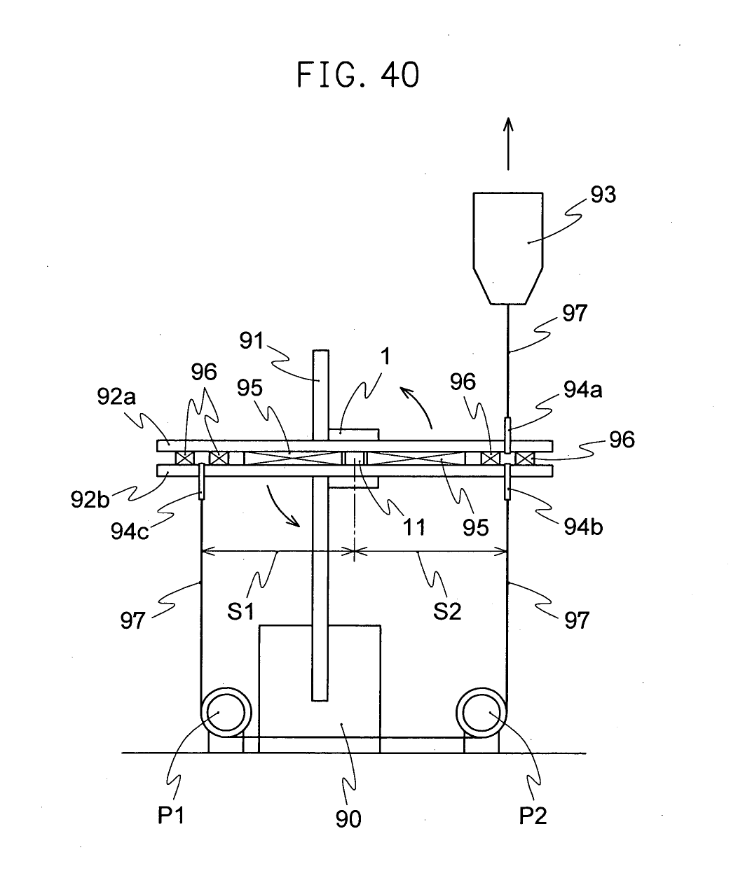

With reference to FIG. 40, the procedure will be explained.
Step 1: At first, the bracket 1 was attached to a ceramic substrate 91.
Step 2: The ceramic substrate 91 was fixed to a clamp holder.
Step 3: A sample arch wire was held using presser plates 92a, 92b and spacers 95, 96.
Step 4: The arch wire 11 held between the presser plates 92a, 92b was inserted into the bracket 1. At this time, the bracket 1 and the arch wire 11 were guided such that they were not subjected to a load, and the presser plate 92a was hooked, with an anchoring hardware 94a, onto a tensing wire rope 97 secured to an upper clamp holder 93. Similarly, the presser plate 92b was hooked onto the tensing wire rope 97 with anchoring hardware 94b, 94c through pulleys P1, P2.
Step 5: The upper clamp holder 93 was moved to adjust the height such that the presser plates 92a, 92b were normal to the ceramic substrate 91.
Step 6: Zero adjustment was performed.
Step 7: Tensile test was started.
Step 8: The loads when the tensile distance was 1 mm, 3 mm, 5 mm and 10 mm were measured and these loads were compared (see Table. 5).

As a result, it was proven that the arch wires having a front-rectangular-rear-round and rectangular cross sections were capable of imposing the same level of torque, while the arch wire having a round cross section was not capable of imposing a torque.

TABLE 5
Unit = gf

| Shape of | | Number of | Pulling distance | | | |
|---|---|---|---|---|---|---|
| section | Size (inch) | analyte (n) | 1 mm | 3 mm | 5 mm | 10 mm |
| Circular | φ0.018 | Average | 0.2 | 0.3 | 0.25 | 0.3 |
| Rectangular | φ0.017 × 0.025 | Average | 2.2 | 12.23 | 21.07 | 52.83 |
| | φ0.018 + | Average | 2.1 | 11.1 | 22.5 | 55.1 |
| | (0.3 mm + | | | | | |
| | 0.2 mm) | | | | | |

Remark: number (n) of analyte was 5

### Industrial Applicability

According to the present invention, there is provided orthodontic brackets which reduce the contact area between the arch wire and the orthodontic bracket, require no ligature with a ligaturing wire or module, and are less prone to be disengaged from a tooth surface.

Further, according to the present invention, there is provided arch wires which, even when used in early stages of treatment where teeth alignment has not corrected, sufficiently follow large bending, experience no excessive bending stress, are less prone to deform, maintain the elasticity, and prevent breakage.

1. An orthodontic bracket to be attached through adhesive to an individual tooth in an alignment of teeth including a tooth to be corrected, comprising:
two claws faced to each other, wherein the two claws form therebetween an engaging slot for engaging an arch wire and the engaging slot has a T-shaped cross section; and
a fixed spacer provided on the bottom of the engaging slot.

2. An orthodontic bracket according to claim 1, wherein the fixed spacer comprises two protruded strips which are in parallel and formed continuously or discontinuously.

3. An orthodontic bracket according to claim 2, wherein the two protruded strips are spaced apart by about 0.25 to 0.75 mm.

4. An orthodontic bracket according to any one of claims 1 to 3, wherein a movable spacer is to be inserted into the engaging slot, the movable spacer comprising two legs and a coupling portion coupling the two legs, and when the movable spacer is inserted into the engaging slot, the movable spacer is placed within the engaging slot such that the two legs are straddle the fixed spacer and at least the outer surfaces of the legs contact the inside surfaces of the claws, and the gap between the two claws is blocked by the coupling portion.

5. An orthodontic bracket according to any one of claims 1 to 3, comprising an undercut formed at the portion which faces to a tooth surface, wherein the undercut is formed from at least two legs each having a substantially dovetail shape cross section.

6. An arch wire to be inserted into engaged by an engaging slot formed by two claws of an orthodontic bracket faced to each, the arch wire comprising waveform curved surfaces formed at arch wire portions which, when the arch wire is inserted into the bracket, contact the inside surfaces of the bracket.

7. An orthodontic bracket to be attached through adhesive to an individual tooth in an alignment of teeth including a tooth to be corrected, comprising:
base, two claws faced to each other and protruded arcuately from the base, and an undercut formed on the side of the base which is opposite the surface on which the two claws are formed,
wherein a metal arch wire having a round cross section can be mounted between the two claws faced to each other.

8. An orthodontic bracket to be attached through adhesive to an individual tooth in an alignment of teeth including a tooth to be corrected, comprising:
base, two claws faced to each other, the claws being protruded from the base and bent, and an undercut formed on the side of the base which is opposite the surface on which the two claws are formed,
wherein a synthetic resin arch wire having a substantially cuneiform shape cross section can be mounted between the two claws faced to each other.

9. An orthodontic bracket to be attached through adhesive to an individual tooth in an alignment of teeth including a tooth to be corrected, comprising:
base, two claws faced to each other and protruded arcuately from the base, a slot formed at the portion where the two claws are bonded, and an undercut formed on the side of the base which is opposite the surface on which the two claws are formed,
wherein an arch wire having a cross section fittable within the slot can be mounted between the two claws faced to each other.

10. Pliers for mounting an arch wire onto an orthodontic bracket, comprising:
a pliers-opening/closing grip; a tooth-backside pressing arm formed integrally with the pliers-opening/closing grip; an arch-wire pressing arm formed integrally with the pliers-opening/closing grip; wherein the pliers-opening/closing grip, the tooth-backside pressing arm and the arch-wire pressing arm are assembled into an X-shape through a shaft and are pivotable about the shaft; and
an arch-wire-fixing-blade operating lever; an arch-wire fixing blade formed integrally with the arch-wire-fixing-blade operating lever; and an arch-wire-fixing blade formed integrally with the arch-wire-pressing arm, through an other shaft provided at the tip end of the tooth-backside-pressing arm, wherein the arch-wire-fixing-blade operating lever and an arch-wire fixing blades are pivotable about said other shaft, the arch-wire-fixing blades have protruded right and left ends each including a recesses for inserting an arch wire, and a cushion is provided at the tip end of the tooth-backside pressing arm.
